(19) United States
(12) Patent Application Publication
(10) Pub. No.: US 2009/0285537 A1
(43) Pub. Date: Nov. 19, 2009

(54) Antitracking Aramid Yarn

(75) Inventors: Stephanus Willemsen, Rheden (NL); Henricus Johannes Franciscus Maria Van De Ven, Arnhem (NL); Hans Jansen, Velp (NL)

Correspondence Address: OLIFF & BERRIDGE, PLC, P.O. BOX 320850, ALEXANDRIA, VA, 22320-4850, US

(73) Assignee: TEIJIN ARAMID B.V., Arnhem (NL)

(21) Appl. No.: 12/227,828

(22) PCT Filed: Jun. 19, 2007
(86) PCT No.: PCT/EP2007/005372

§ 371 Date: Jan. 2, 2009

(30) Foreign Application Priority Data
Jun. 28, 2006 (EP) 06013295.8

(51) Int. Cl. G02B 6/44; D02G 3/02; D02G 3/36; D06M 13/292; B05D 5/12

(52) U.S. Cl. 385/100; 57/257; 57/258; 427/117

(57) ABSTRACT

The invention pertains to an aramid filament yarn provided with a finish composition comprising an organic substance, the amount of organic substance in the finish being selected so that the finish has a conductivity from 0.2 mS/cm to 200 mS/cm, measured as a 50 wt % finish composition in water at 20° C., and the amount of the finish on the yarn being selected so that the yarn has a specific electric resistance from 4×104 to 1.2×107 Ohm.cm. The invention further pertains to an ADSS cable reinforced with bundles of said aramid filament yarn, and to a method for making the ADSS cable.

The invention relates to an anti-tracking aramid filament yarn provided with a finish composition and to an ADSS (All Dielectric Self Supporting) cable made thereof.

ADSS cables are in use for many years, mainly used in regions where a fast implementation of an infrastructure is required. It is of advantage that the installation can be performed at High Voltage Power Lines without turning off the line voltage.

The ADSS cables are installed between poles. The resulting space potential easily can reach levels up to 15 kV due to the electric fields of the high voltage conductors. The difference in space potential between the middle of the span and the pole (cable is grounded there) does not lead to any noticeable current flow as long as the surface resistance of the ADSS cable is high enough.

Field experiences with ADSS cables have shown that the built-up of a dust layer can lead to strong reduction of the surface resistance when such layer gets humid by fog and dew. This enables a current flow of a few milliamperes through the layer of deposit. When the layer gets dry a first dry zone (dry band) can be formed on the cable surface. This dry band has an extremely high surface resistance compared to the humid layer. Consequently the potential difference built up along the cable length drops across the dry band. Thus arcing will occur which is deteriorating for the cable sheath. Cable manufacturers have paid a lot of attention to this problem and implemented measures for mitigation have been implemented. It is well known that the introduction of tracking resistant sheath materials tremendously improves the resistance of the sheath materials against discharges. Despite this improvement the lifetime of ADSS cables in extreme dusty circumstances (such as in a desert) is insufficient.

A further improvement of ADSS cables was disclosed in EP 214480, which describes increasing the electrical conductivity of the aramid yarns below the cable sheath. Due to the capacitive coupling of the cable sheath to the conductive yarns the discharges are less intense. It was noted that the currents through the aramid yarns should not be too high in order to exclude any physical risk for staff working on the cable installation.

The aramid yarns were made electrically conductive by applying a special jelly on the aramid yarns during cable production. It has proven to be difficult to assure a constant and homogeneous distribution of the electrically conductive jelly along the reinforcing yarns in the ADSS cable. As a result the lifetime of such ADSS cable is reduced.

Common ADSS cables contain a core, reinforcing aramid yarn, and an outer sheath. The core contains optical fibers and can be build up as central tube design, which is a hollow tube containing optical fibers in a petro-jelly. In another design there are 5 to 18 hollow tubes in 1 or 2 layers around a glass fiber composite (loose tube design). The hollow tubes contain optical fibers in a petro-jelly. Such loose tube design may have an inner jacket around it, usually made of polyethylene.

For critical applications the outer jacket is made of a special polymer, which is better resistant to sparks (track-resistant polymer).

The aramid yarn is particularly useful for neutralizing tensile forces. Tensile forces are obtained by the weight and the installation tension, and by the presence of wind and ice layers. The outer sheath protects the aramid yarn and the other elements in the inner part of the cable against sun light and water.

The latter is of importance since water moves to the lowest point of the cable. When it freezes considerable compression forces are evolved which leads to signal loss of optical fibers. Optical fibers further are sensitive to hydrogen and water vapor, also leading to signal loss.

Sparks can be formed when the cables contains a dust layer at the outer side (dry-band arcing).

Those sparks may deteriorate the outer sheath, even in very short periods like one week. When a hole is formed in the outer jacket, the aramid is affected and the cable may then break.

We have now found a different method of making the aramid yarns electrically conductive, which assures a homogeneous distribution of the finish along the reinforcing yarns in an ADSS cable.

To this end, the invention pertains to an ADSS cable reinforced with aramid filament yarn provided with a finish composition comprising an organic substance, the amount of organic substance in the finish being selected so that the finish has a conductivity from 0.2 mS/cm to 200 mS/cm, measured as a 50 wt % finish composition in water at 20° C., and the amount of the finish on the yarn being selected so that the yarn has a specific electric resistance from 4×10⁴ to 1.2×10⁷ Ohm.cm.

In another embodiment the invention also pertains to the novel aramid filament yarn per se, which can be used for making ADSS cables that are reinforced with such aramid yarns.

The difference of this method with the method of the prior art is applying a separate treatment of the reinforcing aramid yarn bundles of 1000 to 40000 dtex, before they are embedded in the ADSS cable, and using finishes which comprise specific conductive organic substances, rather than treatment of the ADSS cable as such. By the treatment of the individual aramid yarn bundles with a finish instead of the complete reinforcing aramid material in the cable, it was found that a better penetration into the yarn bundles and a more even distribution could be achieved. As a result the current flow is not disturbed by the presence of bad or untreated yarn parts in the cable.

It was found that when finishes comprising a conductive organic substance (COS) are applied onto aramid filament yarn, the electrical yarn resistance thereof is reduced. Depending on the amount of finish, the amount of the organic substance in the finish, and on the conductivity of the applied organic substance, the treated yarn can be used as anti-tracking yarn in ADSS cables.

The conductive organic substance can be applied onto wet or dried yarn as a spin-finish (before or after the drying, as such or diluted with a solvent such as water) during the spinning process or in a separate process step.

The specific electrical resistance of the yarn may not be too low to avoid dangerous situations (e.g. electrocution) for workers in high voltage power lines and to avoid undesirable temperature rise at the pylons. On the other hand, the specific electrical resistance may not be too high to have sufficient anti-tracking behavior.

It has been found that aramid filament yarns treated with a finish comprising an organic conductive substance and having a specific electric resistance from 4×10⁴ to 1.2×10⁷ Ohm.cm, more preferably from 7×10⁴ to 1×10⁶ Ohm.cm, show excellent anti-tracking behavior in ADSS cables. The amount of organic substance in the finish and the amount of said finish applied onto the yarn can easily be adjusted to obtain the required conductivity and specific electric resistance by applying simple and common electrical measurements which are well known in the art, and which are described herein below. Suitable amounts of finish to be applied can very easily be determined by a simple conductivity measurement, which as such is known in the art. When the conductivity of the finish solution is determined, a skilled person can easily apply the required amount of finish as needed for the specific use.

Amounts of conductive organic substances in the finish giving a conductivity from 0.2 mS/cm to 200 mS/cm measured as a 50 wt % finish composition in water at 20° C. are required. More preferred are finishes with conductivity from 1 mS/cm to 50 mS/cm.

Particularly suitable amounts of finish on the yarn giving the required conductivity and specific electric resistance are within the range 1 to 30 wt %, more preferably within the range 8-22 wt %. The wt % is relative to the total weight of the yarn without finish and moisture.

Suitable organic substances for use in the invention are materials having statically chargeable acid or base groups, or a salt thereof. Non-ionic components can be used as well. Materials with acid groups are preferably fatty acids, (alkyl)phosphates, (alkyl)phosphonates, (alkyl)sulfonates, (alkyl)sulfates, and their salts. Materials with base groups are preferably amine compounds, imidazole derivates and quarternary ammonium compounds and their salts. Particular preferred materials are salts of (alkyl)phosphonates, (alkyl)phosphates, and quaternary ammonium compounds. Acid groups are preferably carboxylate, phosphonate or sulfonate groups. Base groups are preferably amine groups. Particularly preferred materials are fatty acids, carbonic acids, (cyclo)alkyl phosphates, (cyclo)alkyl phosphonates, (cyclo)alkyl sulfates, (cyclo)alkyl sulfonates, imidazoline derivatives, and the like. Particularly suitable are organic substances having a charge density of 80 to 800, preferably 130 to 600, and most preferably 190 to 450. Charge density is defined as the molecular weight of the organic substance divided by the number of chargeable groups in the organic substance molecule.

The aramid yarns preferably are made of poly(p-phenylene terephthalamide) (PPTA), but may also contain minor amounts of other monomers. Preferred aramid has a modulus of at least 90 GPa

The COS is applied onto the yarn by conventional methods known in the art. The COS can be applied in solution. The solvent may be any suitable solvent, such as water, alcohol, ether, tetrahydrofuran, acetone, benzene, toluene, ethyl acetate, dichloromethane, and the like. Most preferably the COS is applied as such, i.e. undiluted.

The invention also pertains to the use of these yarns in cables and to cables comprising said yarns, which cables have the same mechanical characteristics as cables made of the untreated aramid yarns. The invention is particularly useful in ADSS cables.

### Procedure for Lifetime Test of ADSS Cables

To a sample ADSS cable of 6 m length two wire-wound end connections (so-called Chinese fingers) with length of 1 m were attached. A tension of 3.5 kN was applied to the cable, e.g. by means of a hydraulic cylinder. The cable was installed with an angle of 3° with the horizontal plane. Approximately 1 m above the cable a high voltage frame (field electrode) was installed. On the lower end of the cable a well-known torodical field electrode was installed. This electrode was connected to the high-voltage frame by an electrical capacitor of 200 pF. To the high-voltage frame an alternating current high tension can be applied.

A current monitor was installed on the high end of the chamber. The other side of the monitor was connected to earth.

The cable and other equipment mentioned were installed in a chamber in which the air can be refreshed at will by means of ventilator.

Next a paste consisting of 50% of the solid of table 1 and 50% of water was applied to the cable sample between the end connections in a layer of 0.5 mm. Next the ventilators were switched on for until the applied layer is dry (at least 3 hours).

After this preparation the measurements, which are divided in cycles, can start.

First water with 0.4 g/l sodium chloride was sprayed in the atmosphere of the test chamber for 4 minutes, with the ventilators off. This completely saturates the deposit layer on the cable with moisture. Next the chamber was ventilated for 4 minutes to completely remove the moisture. A high tension of 30 kV was now applied to the high voltage frame, with the ventilators still on. (This induced a current through the outside of the cable of at least 1.5 mA.) As the cable dried, the current dropped and sparks may appear on the outside of the ADSS cable, especially at the vicinity of the upper end connection. However, if the current was dropped substantially (below 0.5 mA) no more sparks appeared and the high voltage was switched off after 24 min. The ventilators were switched off and the next cycle started again by spraying the sodium chloride solution.

Once a day the measuring cycles were stopped for at least 4 hours, to allow the deposited layer to dry completely. During this time or when the current in the sparking was increased the jacket of the cable was inspected in the vicinity of the upper end connection. If the jacket was destroyed in such a way that the aramid becomes visible, the test sequence was ended and the number of cycles was recorded.

TABLE I
composition of deposit layer

| Component | Mass fraction |
|---|---|
| sodium chloride | 3% |
| gypsum | 10% |
| chalk | 32% |
| clay | 50% |
| cement | 5% |

### Procedure for the Determination of the Conductivity of a Finish

A suitable procedure to determine the conductivity of a finish composition according to the invention is as follows.

A sufficient amount of the aqueous finish solution (50 wt % of water and 50 wt % of COS) to be tested was poured into a beaker. Subsequently, the conductivity of this solution was determined according DIN norm 38404 Teil 8 (9.1985) at a temperature of 20° C.

When the finish containing the COS has a lower or higher water content than 50 wt %, the concentration of the finish solution was adjusted to 50 wt % by respectively the addition of demineralized water or the evaporation of water by heating on a hot plate under stirring at an elevated temperature below 100° C. For the measurement of the conductivity, a conductivity meter type inoLab of the Wissenschaftlich-Technische Werkstätten GmbH, Weilheim, Germany was used.

The water content of the finish solution was determined by the Karl Fischer method. An exact description of the determination of water via Karl Fischer reagent is given in “Karl Fischer Titration, Methoden zur Wasserbestimmung” by Eugen Scholz, Springer-Verlag 1984.

### Procedure for the Determination of the Specific Electrical Resistance

For the determination of the specific electrical resistance of the aramid yarns a sample-holder consisting of two copper bars separated by two polytetrafluoroethylene rods was used. The mutual distance of the bars is 52 mm. The yarn to be tested (preferably between 7600 and 11000 dtex) was wound a number of times (preferably between 11 and 15) times around the two copper bars which were connected with a DC high voltage power source and a Keithley electrometer. With the Keithley electrometer the electrical current was determined after a voltage of 500 V was applied over the copper bars at 20° C. and 65% relative humidity. The specific electrical resistance of the yarn was calculated based on Ohm's law, the yarn length between the copper bars, the number of yarn connections, and the cross-section area of the yarn.

The invention is further illustrated with the following non-limitative examples.

### EXAMPLE 1

A yarn package of commercially available high modulus Twaron® D2200 (9660 dtex/f 6000) was subjected to the following treatment. The yarn package was rollingly unwound while successively passing the yarn over a liquid applicator and through a hot air oven (temperature 200° C., residence time 10 seconds). Next the treated aramid yarn was wound into a package at a speed of 30 m/min. With a liquid applicator and a metering pump, the yarn was treated with the COS-containing finish a1 (Table A). This finish was diluted with the solvent toluene to achieve a homogeneous distribution of the finish. During the heat-treatment, the solvent toluene was evaporated. The specific electrical resistance of the treated yarn was measured.

Next, an optical fiber cable was produced containing a central tube filled with optical glass fibers in petro-jelly and reinforced with the treated aramid yarns. To that end, a jacket of a tracking-resistant polymer having a thickness of 2 mm was extruded around the central tube with 6 mm outside diameter that was wrapped up in 27 (×9660 dtex/f 6000) treated yarns. The outside diameter of the cable was around 12 mm.

### EXAMPLE 2

### Comparative

The same optical fiber cable of example 1 was produced using the following procedure during the extrusion process. The central tube filled with optical glass fibers and petro-jelly, was wrapped up in 27 high modulus Twaron® D2200 yarns (9660 dtex/f 6000). The finish a2 was dosed onto the reinforcing yarns using a funnel and the cable was pulled through a die to achieve a homogeneous distribution of the finish. Finally the tracking-resistant jacket was extruded around the cable.

Both optical fiber cables of examples 1 and 2 with the same amount of COS and reinforcing material were tested in a test cabin on their anti-tracking behavior. The results are shown in Table B. It is obvious that an optical fiber cable with a better anti-tracking behavior is obtained when instead of the bulk amount of aramid in the cable, the individual aramid yarns are treated with the COS containing finish.

### EXAMPLES 3 TO 5

In examples 3 to 5, almost the same procedure was performed to produce the optical fiber cable as mentioned in example 1. Only the amount and the type of the COS was changed and instead of a diluted finish, the finishes were used as such (Table A). As a result the yarn drying treatment could be omitted.

The results are shown in Table C.

It is shown that optical fiber cables with an improved tracking resistance can be obtained when the reinforcing aramid yarns are separately treated with a COS containing finish.

TABLE A
Composition of finishes containing conductive organic substances

| Name | Finish code | | | | |
|---|---|---|---|---|---|
| component | a1 | a2 | b | c | d |
| LA 499 ® | 45 | 100 | | | |
| Zerostat ® TFG | | | 100 | | |
| Leomin ® AN | | | | 15 | |
| Afilan ® PTU | | | | 85 | 100 |
| toluene | 55 | | | | |
| Total | 100 | 100 | 100 | 100 | 100 |

LA 499® is a mixture of isononyl phosphate ester, diethanolamine salt (60-80%) and polyethylene glycol iso-nonylphenol (<25%), supplier Info-Lab Ltd., Limerick, Ireland. Zerostat® TFG is a mixture of a quarternary ammonium salt (tris(2-hydroxyethyl)methylammonium methylsulfate) and boric diethanol amine, supplier Ciba Specialty Chemicals, Groot-Bijgaarden, Belgium.

Leomin® AN is an ethyl octyl phosphonate potassium salt, supplier Clariant GmbH, Frankfurt, Germany.

Afilan® PTU is an ethoxylated and propoxylated oleic acid, CH3-capped, supplier Clariant GmbH, Frankfurt, Germany.

Toluene is an aromatic hydrocarbon (solvent), supplier Sigma-Aldrich, Saint Louis, USA.

TABLE B
Test results

| | Experiment No. | |
|---|---|---|
| Description | 1 | 2 (comparative) |
| Finish composition applied with: | | |
| a liquid applicator on yarn | a1 | — |
| a funnel on combined yarns in the cable | — | a2 |
| COS amount on yarn (wt %) | 15 | 15 |
| Conductivity of a 50 wt % finish | 4.43 | 4.43 |
| composition in mS/cm at 20° C. | | |
| Specific electrical resistance of the | 9.5 * 10⁴ | 2.3 * 10⁸ |
| yarn in Ohm · cm | | (without COS) |
| Test performed in the high voltage | | |
| test cabin: | | |
| number of tests | 6 | 5 |
| cycles to failure (median) | 976 | 135 |

TABLE C
Test results

| | Experiment No. | | |
|---|---|---|---|
| Description | 3 | 4 | 5 |
| Finish composition applied with: | | | |
| a liquid applicator on yarn | b | c | d |
| COS amount on yarn (wt %) | 1 | 15 | 15 |
| Conductivity of a 50 wt % finish | 28.7 | 2.42 | 0.30 |
| composition in mS/cm at 20° C. | | | |
| Specific electrical resistance of the | 7.6 * 10⁴ | 1.2 * 10⁵ | 1.10 * 10⁷ |
| yarn in Ohm · cm | | | |
| Test performed in the high voltage | | | |
| test cabin | | | |
| number of tests | 5 | 11 | 5 |
| cycles to failure (median) | 841 | 1157 | 360 |

1. An aramid filament yarn provided with a finish composition at least comprising an organic substance, the finish having a conductivity from 0.2 mS/cm to 200 mS/cm measured as a 50 wt. % finish composition in water at 20° C., and the yarn having a specific electric resistance from 4×10⁴ to 1.2×10⁷ Ohm.cm.

2. The aramid filament yarn of claim 1 wherein the conductivity is from 1 mS/cm to 50 mS/cm.

3. The aramid filament yarn of claim 1 wherein the specific electric resistance is from 7×10⁴ to 1×10⁶ Ohm.cm.

4. The aramid filament yarn of claim 1 wherein the yarn comprises 1 to 30 wt. %, preferably 8 to 22 wt. %, of the finish composition

5. The aramid filament yarn of claim 1 wherein the organic substance contains at least one statically chargeable acid or base group which may be in the form of a salt.

6. The aramid filament yarn of claim 5 wherein the organic substance contains at least one of a carboxylate, phosphonate, phosphate, sulfonate, sulfate, and amine group or wherein the organic substance is an imidazole derivate or a quarternary ammonium compound.

7. The aramid filament yarn of claim 6 wherein the organic substance is a salt of an (alkyl)phosphate, an (alkyl)phosphonate, or is a quarternary ammonium compound.

8. The aramid filament yarn of claim 1 wherein the aramid is poly(p-phenylene terephthalamide) (PPTA).

9. The aramid filament yarn of claim 8 wherein the aramid has a modulus of >90 GPa.

10. An ADSS cable reinforced with bundles of the aramid filament yarn of claim 1.

11. The ADSS cable of claim 10 wherein the individual yarn bundles have a linear density of 1000 to 40000 dtex.

12. The ADSS cable of claim 10 wherein the outer jacket is made of a tracking-resistant polymer.

13. A method for making the ADSS cable of claim 10 wherein aramid filament yarn is treated with a finish composition at least comprising an organic substance, wherein the finish has a conductivity from 0.2 mS/cm to 200 mS/cm measured as a 50 wt. % finish composition in water at 20° C., and the yarn has a specific electric resistance from 4×10⁴ to 1.2×10⁷ Ohm.cm, and thereafter embedding bundles of the yarn in a cable comprising components that are usual for ADSS cables.
